(19) United States
(12) Patent Application Publication
(10) Pub. No.: US 2015/0363510 A1
(43) Pub. Date: Dec. 17, 2015

(54) INDEXED SHAPED GRAPH CREATION

(71) Applicant: HEWLETT-PACKARD DEVELOPMENT COMPANY, L.P., Houston, TX (US)

(72) Inventors: Qunyang LIN, Beijing (CN); Junqing XIE, Beijing (CN); David LEE, Palo Alto, CA (US)

(21) Appl. No.: 14/763,797

(22) PCT Filed: Jan. 31, 2013
(86) PCT No.: PCT/US13/24132

§ 371 Date: Jul. 27, 2015

(51) Int. Cl. G06F 17/30

(52) U.S. Cl. CPC G06F 17/30958; G06F 17/30371; G06F 17/30327

(57) ABSTRACT

Index shaped graph creation can receive a number of bit-strings through a communication link. Index shaped graph creation can create a binary tree from a number of nodes that represent the number of bit-strings. Index shaped graph creation can define an index table based on the binary tree that includes the number of bit-strings and a number of indexes for the number of bit-strings. Index shaped graph creation can create a shaped graph based on the binary tree, wherein the shaped graph compresses a portion of the number of nodes. Index shaped graph creation can convert the shaped graph into an indexed shaped graph by assigning each of a compressed number of nodes in the shaped graph an offset value that can be associated with the number of indexes in the index table.

### BACKGROUND

A data structure can include a representation of a number of characters. A data structure can be traversed to extract the number of characters. Data structures can require memory resources and processing resources associated with the indexing and look-up of the number of characters.

A binary tree can be a data structure that stores a number of characters such that the binary tree can be traversed to retrieve a string of characters. However, as the size of the strings of characters that are stored in a binary tree increases, the memory allocation used to store the string of characters also increases. Reducing the memory allocated to storing information in the binary tree without losing information can provide for a more efficient data structure than a binary tree.

### BRIEF DESCRIPTION OF THE DRAWINGS

FIG. 1A is a diagram illustrating an example of a bit-string list according to the present disclosure.

FIG. 1B is a diagram illustrating an example of a binary tree according to the present disclosure.

FIG. 1C is a diagram illustrating an example of an indexed shaped graph according to the present disclosure.

FIG. 2A is a diagram illustrating an example of a bit-string list according to the present disclosure.

FIG. 2B is a diagram illustrating an example of a binary-tree that includes a common prefix according to the present disclosure.

FIG. 2C is a diagram illustrating an example of an indexed shaped graph that includes a common prefix according to the present disclosure.

FIG. 3A is a diagram illustrating an example of slicing a token list according to the present disclosure.

FIG. 3B is a diagram illustrating an example of slice compression according to the present disclosure.

FIG. 4 is a flowchart illustrating an example of query look-up according to the present disclosure.

FIG. 5 is a flow chart illustrating an example of a method for indexed shaped graph creation according to the present disclosure.

FIG. 6 is a diagram illustrating an example of a computing system according to the present disclosure.

### DETAILED DESCRIPTION

The use of a data structure can be associated with memory resources and processing resources. For example, a data structure can exist in memory and the amount of memory occupied by the data structure can be proportional to the type of data and/or the size of the information that is associated with the data structure. A processing resource can be associated with a data structure based on the processing resources that are required to retrieve information from the data structure. Reducing the size of the memory resources and the processing resources needed to construct a data structure and retrieve information from the data structure can influence the efficiency of the data structure and can provide for a better alternative as compared to data structures that are associated with greater usage of memory resources and/or processing resources.

As used herein, a data structure can be an organization of information in memory. Data structures can be differentiated by the organization scheme used to store the information. Information can refer to strings and/or integers, e.g., text and/or numbers, among other data types. Information can be stored in data structures in the form of tokens. Information can be divided into tokens, e.g., tokenized, such that a number of tokens are associated with a number of characters. For example, a string “abc” can be tokenized into a first token representing the character “a”, a second token representing the character “b”, and a third token representing the letter “c”. The tokens can be stored in a data structure.

In previous approaches, a binary tree, e.g., a data structure, can be used to store a number of lists of tokens, e.g., information. However, the memory resources and the processing resources associated with storing the number of lists of tokens in a binary tree can be reduced by associating shapes with the binary tree and condensing portions of the binary tree that have similar shapes to create a shaped graph. The shaped graph can be indexed to accommodate look-up capabilities on the shaped graph. An indexed shaped graph is created when the shaped graph is indexed.

In the present disclosure, reference is made to the accompanying drawings that form a part hereof, and in which is shown by way of illustration how a number of examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

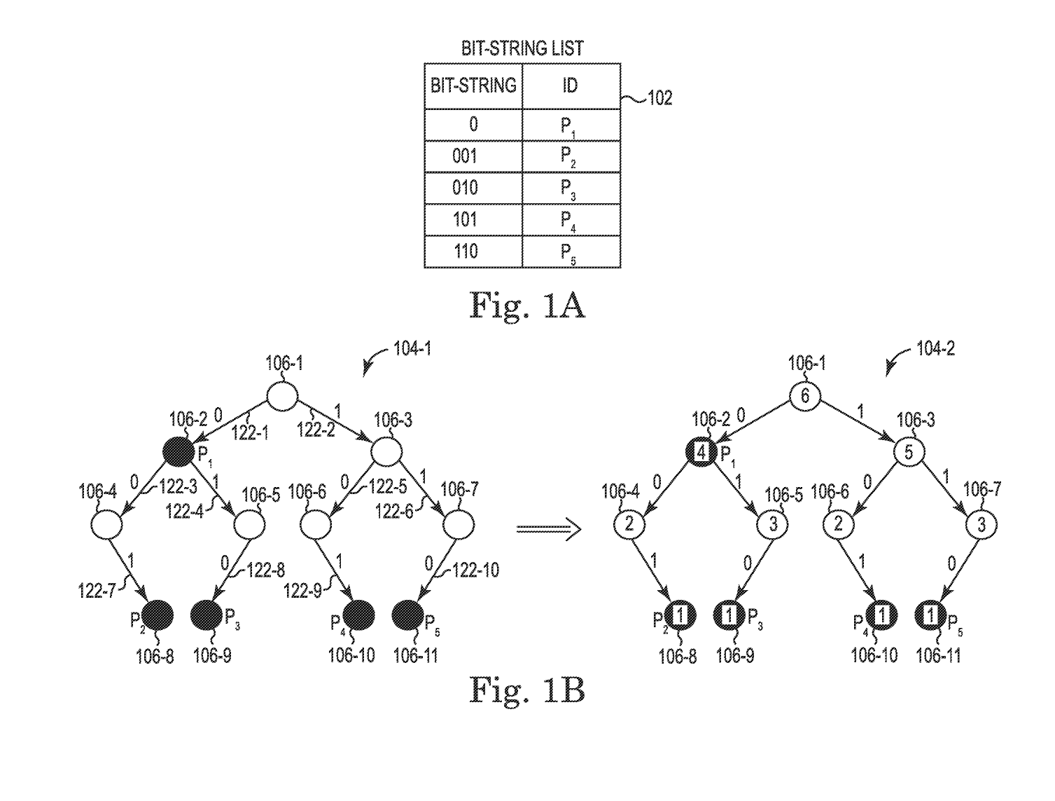

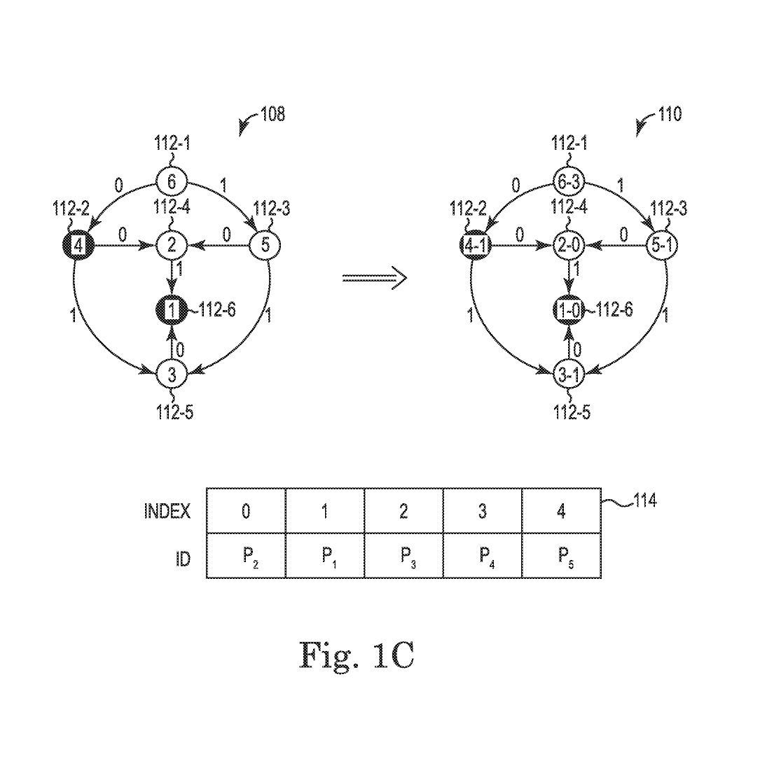

FIG. 1A is a diagram illustrating an example of a bit-string list 102 according to the present disclosure. The bit-string list 102 includes a first bit-string “0” with an associated bit-string identification (ID) “P1”, a second bit-string “001” with an associated bit-string ID “P2”, a third bit-string “010” with an associated bit-string ID “P3”, a fourth bit-string “101” with an associated bit-string ID “P4”, and a fifth bit-string “110” with an associated bit-string ID “P5”.

As used herein, a bit-string can represent information that is in binary form. For example, the binary “0” can represent the decimal number 0, the binary “001” can represent the decimal number 1, the binary “010” can represent the decimal number 2, the binary “101” can represent the decimal number 5, and the binary “110” can represent the decimal number 6. The bit-strings can be tokenized such that each character, e.g., “0” or “1”, in a bit-string is associated with a token. A list of tokens can represent a bit-string. For example, the binary “101” can be represented by a first token that represents “1”, a second token that represents “0”, and a third token that represents “1”. The first token, the second token, and the third token can constitute a list of tokens that represent the binary “101”.

As used herein, a token can be an object that represents a binary character, e.g., “0” and/or “1”, and/or a text character, e.g., “a”, “b”, and/or “c”, among other text characters. Tokens can be linked together using a number of pointers to create a list of tokens. In a number of examples, the bit-string list can define each of the bit-strings as a list of individual characters and/or as a list of tokens. As used herein, a token list and a bit-string list are used interchangeably and as such a token and a bit are also used interchangeably.

FIG. 1B is a diagram illustrating an example of a binary tree according to the present disclosure. FIG. 1B includes a binary tree 104-1, a binary tree 104-2, a number of nodes 106-1, 106-2, 106-3, 106-4, 106-5, 106-6, 106-7, 106-8, 106-9, 106-10, and 106-11, e.g., referred to generally as nodes 106. The binary tree 104-2 is a representation of the binary tree 104-1 with a number of associated shape ID's.

As used herein, a binary tree is an ordered tree data structure. In a number of examples, a binary tree can be a binary tree, among other types of binary tree structures. A binary tree can include a number of nodes, e.g., objects, that define a number of lists of tokens stored in the binary tree. A binary trie can be a binary tree wherein no single node defines a list of tokens but rather the position of a node within the binary tree and a number of other nodes that connect the node to a root node, e.g., path from the node to the root node, of the binary tree can define a list of tokens.

The number of nodes 106 can be connected by edges. The edges 122-1, 122-2, 122-3, 122-4, 122-5, 122-6, 122-7, 122-8, 122-9, 122-10, e.g., referred to generally as edges 122, that connect the number of nodes can be associated with a binary character, e.g., “1” and/or “0”. In a number of examples, the edges can be associated with text characters, among other types of characters. In a binary tree each node is associated with a right edge, e.g., “1”, and a left edge, e.g., “0”. For example, the root node 106-1 can be connected to the node 106-2 through the edge 122-1, e.g., “0”, and to the node 106-3 through the edge 122-2, e.g., “1”. The node 106-2 can be associated with the node 106-4 through the edge 122-3, e.g., “0”, and to the node 106-5 through the edge 122-4, e.g., “1”. The node 106-3 can be associated with the node 106-6 through the edge 122-5, e.g., “0”, and the node 106-7 through the edge 122-6, e.g., “1”. The node 106-4 can be connected to the node 106-8 through the edge 122-7, e.g., “1”. The node 106-5 can be connected to the node 106-9 through the edge 122-8, e.g., “0”. The node 106-6 can be connected to the node 106-10 through the edge 122-9, e.g., “1”. The node 106-7 can be connected to the node 106-11 through the edge 122-10, e.g., “0”.

Each of the bit-strings identified in FIG. 1A can be associated with a number of nodes in binary tree 104-1 and a binary tree 104-2. For example, a bit-string with a value of “0” can be associated with the nodes 106-1 and 106-2. That is, starting at the root node, a path can be followed from node 106-1 through edge 122-1 to node 106-2 where a bit-string with a value of “0” terminates. Node 106-2 can denote by a shading of node 106-2 that a bit-string terminates at the node 106-2. The node 106-2 can denote the termination of a bit-string at the node 106-2 with a flag and/or a variable that can be toggled to indicate the termination of a bit-string at the node 106-2. As used herein, a node can be valid if a bit-string terminates at the node. In a number of examples, the node 106-2 does not hold the value “0” although node 106-2 can be associated with a bit-string value “0”. The bit-string “001” in FIG. 1 can be associated with the nodes 106-1, 106-2, 106-4, and 106-8. The shading of the node 106-8 can denote that a bit-string terminates at node 106-8.

The nodes 106 and the edges 122 that make up the binary tree 104-1 can be located in memory. That is, the eleven nodes associated with binary tree 104-1 can be located in memory. To reduce the memory resources associated with building the binary tree and storing the bit-strings in FIG. 1A, a number of nodes required to represent the bit-strings can be reduced.

A reduction of the nodes associated with storing the bit-strings can begin with compressing a portion of the nodes 106 in binary tree 104-1. As used herein, a compression of a number of nodes can include representing a number of nodes as a single node such that only one node is associated with the number of nodes.

A compression process can begin with associating a shape with each of the nodes and assigning each shape a shape ID. The compression process begins at the leaf nodes in a binary tree. A leaf node denotes a node that does not have an associated child node. A shape of a node can be defined by a shape of a left sub-node, a shape of a right sub-node, and the validity of a node, e.g., whether a bit-string concludes at the node. The shape of a left sub-node, the shape of a right sub-node, and the validity of the node can be referred to as a triple and can be denoted as “<left sub-node shape, right sub-node shape, validity flag>”. The shape ID of each node in the binary tree 104-2 is indicated by the number within each node. As used herein, a bit-string concludes at a node when a path from a root node to the concluding node represents a bit-string.

For example, the shape of node 106-8 can be defined by the triple “<, , valid>” because the node 106-8 does not have an associated right sub-node and an associated left sub-node and because the node 106-8 is a valid node. The shape “<, , valid>” can be assigned a shape ID of 1. The shape ID can be associated with a given node. For example, node 106-8 can be associated with shape ID 1. The nodes 106-9, 106-10, and 106-11 can be associated with shape ID 1 because the nodes 106-9, 106-10, and 106-11 have an associated shape that is defined by the triple “<, , valid>”. Nodes that share a shape ID will be compressed into a single node.

The shape of node 106-4 can be defined by the triple “<, 1, non-valid>” because the node 106-4 does not have an associated left sub-node, because the right sub-node has a shape defined by node id 1, and because node 106-4 is not a valid node, e.g., a bit-string does not conclude at the node 106-4. The shape “<, 1, non-valid>” can be associated with a shape ID 2. The shape of node 106-6 can also be associated with a shape ID 2.

The shape of the nodes 106-5, 106-7 can be defined by the triple “<1, , non-valid>” which can be associated with a shape ID 3. The shape of node 106-2 can be defined by triple “<2, 3, valid>” because the left sub-node, e.g., node 106-4, has an associated shape ID 2, because the right sub-node, e.g., node 106-5, has an associated shape ID 3, and because the node 106-2 is a valid node. The shape of node 106-3 can be defined by triple “<2, 3, non-valid>” and can be associated with a shape ID 5. The shape of node 106-1 can be defined by triple “<4, 5, non-valid>” and can be associated with a shape ID 6. The nodes 106, the shapes IDs, and the edges 122 can be used to create a shaped graph.

FIG. 1C is a diagram illustrating an example of an indexed shaped graph according to the present disclosure. FIG. 1C includes a shaped graph 108, an indexed shaped graph 110, and an index table 114.

As used herein, the shaped graph 108 and the indexed shaped graph 110 can be created, e.g., composed, based on the binary tree 104-2 in FIG. 1B. The shaped graph 108 and the indexed shaped graph 110 can include a number of edges that can be directed, e.g., the edges can have an associated direction that begins at a root compressed node and ends at the leaf compressed nodes. The shaped graph 108 and the indexed shaped graph 110 include a number of compressed nodes 112-1, 112-2, 112-3, 112-4, 112-5, and 112-6, e.g., referred to generally as compressed nodes 112.

The compressed nodes 112 can be created based on the nodes 106 in FIG. 1B. For example, a compressed node 112-1 can be associated with a node 106-1 in FIG. 1B. A compressed node 112-2 can be associated with a node 106-2 in FIG. 1B. A compressed node 112-3 can be associated with a node 106-3 in FIG. 1B. A compressed node 112-4 can be associated with the nodes 106-4 and 106-6 in FIG. 1B. That is, the nodes 106-4 and 106-6 in FIG. 1B can be compressed into a single node to create compressed node 112-4. The nodes can be compressed because nodes 106-4 and 106-6 in FIG. 1 share the same shape ID, e.g., shape ID 2. A compressed node 112-5 can be associated with the nodes 106-5 and 106-7 in FIG. 1B. A compressed node 112-6 can be associated with the nodes 106-8, 106-9, 106-10, and 106-11 in FIG. 1B.

The shaped graph 108 and the indexed shaped graph 110 can store bit-strings more efficiently than the binary tree 104-2 in FIG. 1B because binary tree 104-2 includes more nodes than the shaped graph 108 and more nodes than the indexed shaped graph 110.

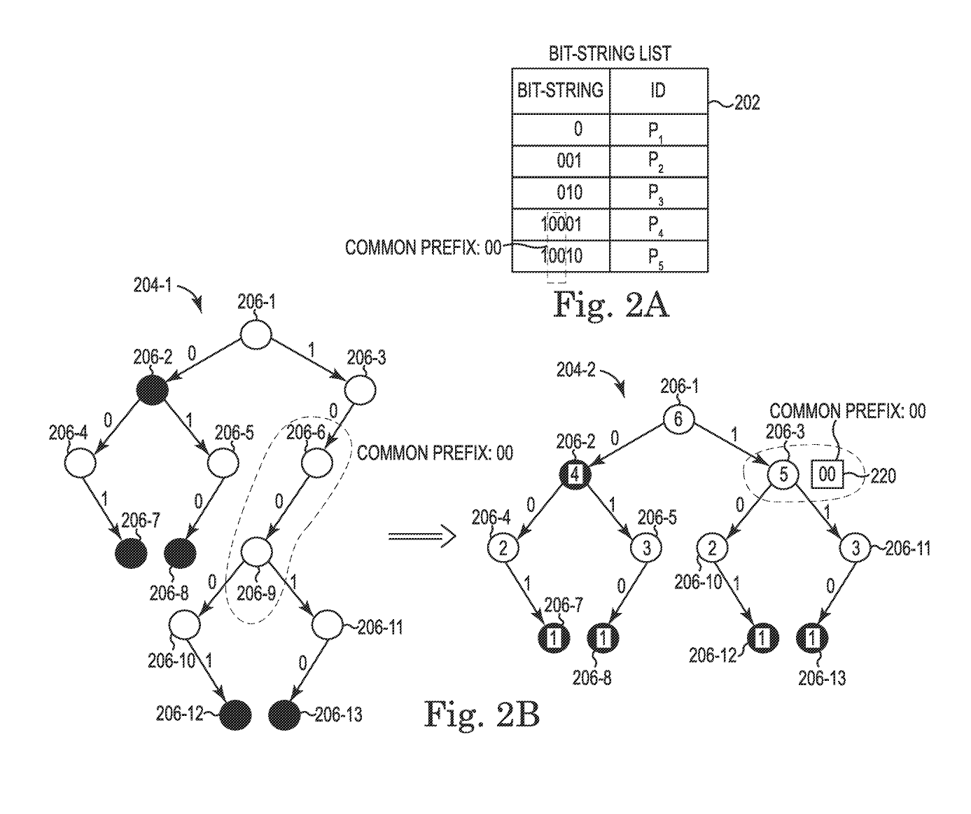

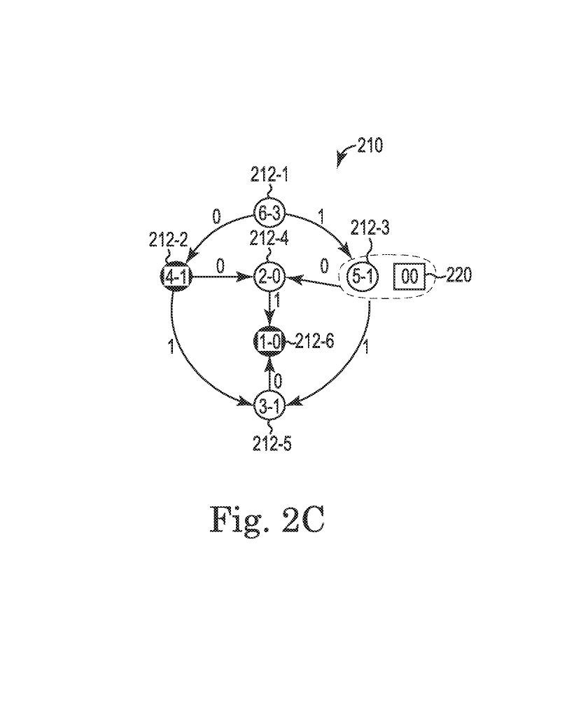

In the shaped graph 108 and the indexed shaped graph 110 a number of compressed nodes can be darkened, e.g., shaded, to represent the conclusion of a bit-string. For example, the bit-string “0” can conclude at compressed node 112-2. The shaped graph 108 and the indexed shaped graph 110 can include a representation of the number of bit-strings in FIG. 1A. An offset value can be associated with each of the compressed nodes 112 in the indexed shaped graph 110. The offset value can be used to associate a compressed node with a number of bit-strings, wherein the path from the root compressed node to the compressed node can be a common prefix that is associated with the number of bit-strings. In the indexed shaped graph 110 the offset value can be indicated by the number to the right of the character “-” within each of the compressed nodes 112. The shape ID that is associated with each of the nodes in the indexed shaped graph 110 is indicated by the number to the left of the character “-” in each of the compressed nodes 112. In the shaped graph 108 the shape ID is indicated by the number in each of the compressed nodes 112. The number of bit-strings can be indexed to reduce the processing resources needed to retrieve a bit-string from the indexed shaped graph 110 and to identify the number of bit-strings that are associated with a common prefix. Common prefixes will be further discussed in FIG. 2A.

The indexed shaped graph 110 can include the compressed nodes 112 and their associated edges. Indexed shaped graph 110 can further include an offset value for each of the compressed nodes 112. An offset value can represent the number of bit-strings that conclude in any of the sub-paths associated with a corresponding node, e.g., common prefix. The type of association used can dictate how the bit-strings are retrieved from the indexed shaped graph 110. For example, an offset value can represent the number of bit-strings that conclude at a number of nodes that are in a left sub-graph. A left sub-graph can be in relation to a given value associated with an edge. For example, an edge that represents a path that is followed for bits with a “0” value can be a left path used in determining the left sub-graph.

The compressed node 112-6 can have an offset value of “0” because the compressed node 112-6 does not have an associated left sub-graph. Compressed node 112-4 can have an offset value of “0” because the compressed node 112-4 does not have an associated left sub-graph, e.g., sub-graph that branches from an edge that represents a bit with a “0” value, even though the compressed nodes does have an associated right sub-graph, e.g., node 112-6. Compressed node 112-2 can have an offset value of “1” because the compressed node 112-2 is associated with a left sub-graph, e.g., compressed nodes 112-4 and 112-6, that includes a single node at which a bit-string terminates, e.g., bit-string “001” terminates at node 112-6. The compressed node 112-3 can have an offset value of “1” because the compressed node 112-3 is associated with a left sub-graph, e.g., compressed nodes 112-4 and 112-6, that includes a single node at which a bit-string terminates, e.g., bit-string “101” terminates at node 112-6. The compressed node 112-1 can have an offset value of “3” because the compressed node 112-1 is associated with a left sub-graph, e.g., compressed nodes 112-2, 112-4, 112-5, and 112-6, that includes three node at which a bit-string terminates, e.g., bit-string “0” terminates at node 112-2, bit-string “001” terminates at node 112-6, and bit-string “010” terminates at node 112-6.

The index table 114 can be associated with the indexed shaped graph 110. The index table 114 and the indexed shaped graph 110 can be used to retrieve bit-strings from the indexed shaped graph 110. The index table 114 can include a number of bit-string IDs and a number of associated indexes. For example, the index table 114 can include a bit-string ID “P2” and an associated index “0”, a bit-string ID “P1” and an associated index “1”, a bit-string ID “P3” and an associated index “2”, a bit-string ID “P4” and an associated index “3”, and a bit-string ID “P5” and an associated index “4”.

The indexes that are associated with the bit-string IDs can be assigned based on a traversal of the valid nodes in the binary tree 104-2 in FIG. 1B. For example, a node 106-8 in FIG. 1B can be a valid node that is traversed first and as a result the bit-string, e.g., 001, that terminates at the node 106-8 can be assigned an index “0”. A node 106-2 in FIG. 1B can be a valid node that is traversed second and as a result the bit-string, e.g., 0, that terminates at the node 106-2 can be assigned an index “1”.

In a number of examples, the assignment of the bit-string IDs can correspond with a traversal of the valid nodes in the indexed shaped graph 110. A number of different traversals of the indexed shaped graph and/or the binary tree 104-2 in FIG. 1B can be used. For example, an in-order traversal of the binary tree 104-2 in FIG. 1B can be used.

FIG. 2A is a diagram illustrating an example of a bit-string list according to the present disclosure. The bit-string list 202 can include a number of bit-strings wherein a portion of the bit-strings share a common prefix. For example, the bit-string list 202 can include a first bit-string with a “10001” value and a second bit-string with a “10010” value. A common prefix is a number of bits, e.g., characters, that are common between two different bit-strings. For example, the first bit-string can have a common prefix with a value of “00”, e.g., “10001” and the second bit-string can have the same common prefix with a value of “00”, e.g., “10010”. In a number of examples, the bit-strings must have the same bits in the same position within the bit-string to have a common prefix.

FIG. 2B is a diagram illustrating an example of a binary-tree that includes a common prefix according to the present disclosure. FIG. 2B includes a binary tree 204-1, a binary tree 204-2, a number of nodes 206-1, 206-2, 206-3, 206-4, 206-5, 206-6, 206-7, 206-8, 206-9, 206-10, 206-11, 206-12, and 206-13, e.g., referred to generally as nodes 206.

The common prefix defined in FIG. 2A with a “00” value can be represented in the binary tree 204-1 by the nodes 206-6 and 206-9. The nodes 206-6 and 206-9 can represent the common prefix because the edge between the nodes 206-3 and 206-6 can represent a character with a “0” value and because the edge between the nodes 206-6 and 206-9 can also represent a character with a “0” value. The nodes 206-6 and 206-9 can also represent the common prefix because the nodes 206-6 and 206-9 represent a path without multiple branches. The nodes 206-6 and 206-9 can be compacted into a single node that represents the common prefix 220 in binary tree 204-2, e.g., compact binary tree. The nodes 206-6 and 206-9 in binary tree 204-1 can be represented by the node 206-3 in binary tree 204-2.

Each of the nodes 206 in binary tree 204-2 can be assigned a shape ID that is based on a triple “<left sub-node shape, right sub-node shape, validity flag>”. In a number of examples, the shape of a node can include a description of an associated common prefix such that a shape ID can be based on quad “<left sub-node shape, right sub-node shape, validity flag, common prefix flag>”. A common prefix flag can be defined by the value of the common prefix, e.g., common prefix 220 with a “00” value.

FIG. 2C is a diagram illustrating an example of an indexed shaped graph that includes a common prefix according to the present disclosure. FIG. 2C includes an indexed shaped graph 210 that is composed of a number of compacted nodes 212-1, 212-2, 212-3, 212-4, 212-5, and 212-6, e.g., referred to generally as compacted nodes 212.

A shaped graph (not shown) can be created based on the binary tree 204-2 in FIG. 2B. The indexed shaped graph 210 can be created based on the shaped graph. The shaped graph and the indexed shaped graph 210 can include a representation of node 206-3 in FIG. 2B. For example, compacted node 212-3 can be associated with node 206-3 in FIG. 2B. The compacted node 212-3 can be associated with a common prefix 220 with a “00” value.

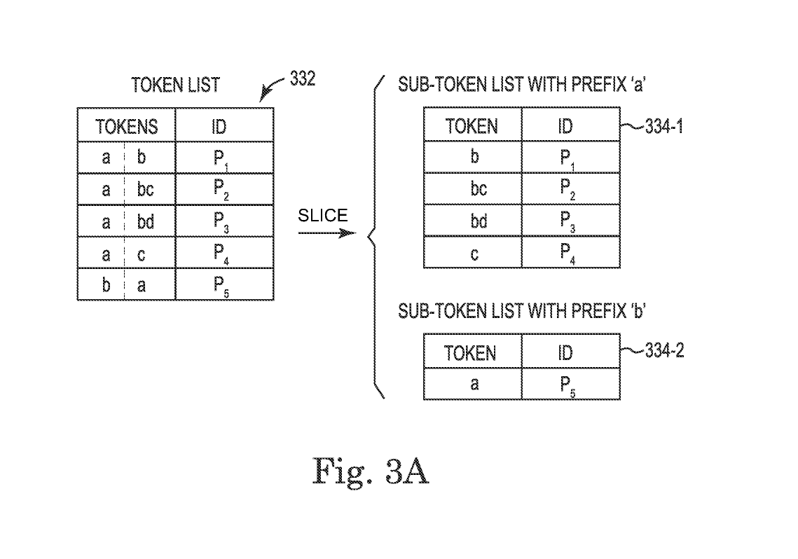

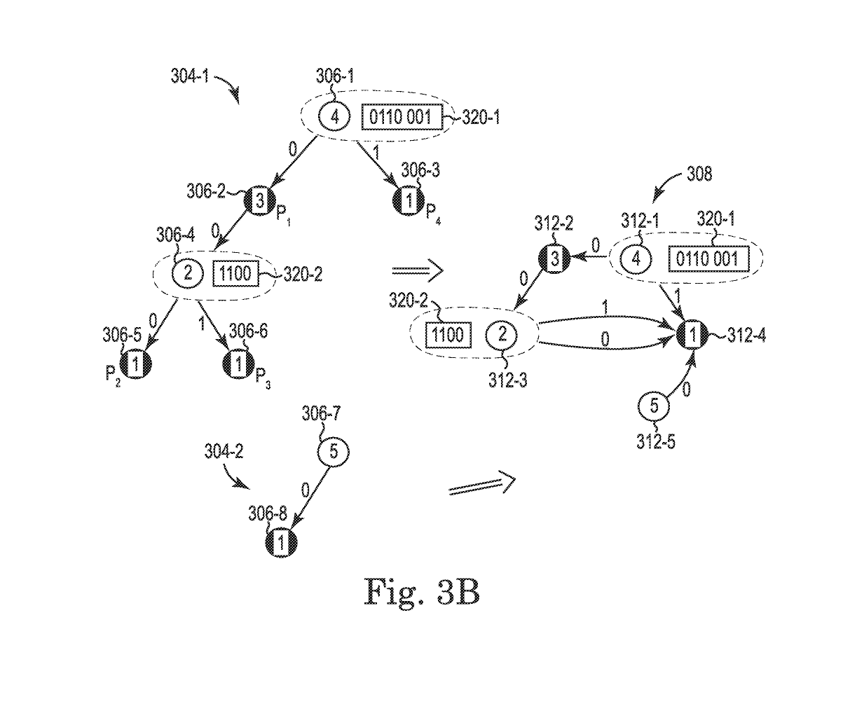

FIG. 3A is a diagram illustrating an example of slicing a token list according to the present disclosure. FIG. 3A includes a token list 332, a sub-token list 334-1, and a sub-token list 334-2.

The token list 332 can include tokens “ab” with a token ID “P1”, tokens “abc” with a token ID “P2”, tokens “abd” with a token ID “P3”, tokens “ac” with a token ID “P4”, tokens “ba” with a token ID “P5”. The token list 332 can be divided into two sub-token lists. A token ID can be an identification that can be associated with a list of tokens.

Sub-token list 334-1 can include a token “b” that is associated with tokens “ab”, a token “bc” that is associated with tokens “abc”, a token “bd” that is associated with tokens “abd”, and a token “c” that is associated with tokens “ac”. Sub-token list 334-1 can be divided from token list 332 based on a prefix. For example, all of the tokens in sub-token list 334-1 have a common prefix, e.g., “a”. Sub-token list 334-2 can be separate from sub-token list 334-1 because sub-token list 334-2 does not have the common prefix “a” but rather can be associated with prefix “b”. Sub-token list 334-2 can include a token “a” that is associated with tokens “ba”.

The token list 332 can be divided into sub-token lists 334-1 and 334-1 to reduce the memory resources. An indexed shaped graph created from a token list 332 can use more memory resources than an indexed shaped graph that is created from the sub-token lists 334-1 and 334-2. Dividing the token list removes the need to represent the common prefixes associated with each of the sub-token lists 334-1 and 334-2, with nodes and thus, reduces the memory resourced needed by an associated indexed shaped graph.

The tokens in sub-token lists 334-1 and 334-2 can be converted to bit-strings. For example, a token associated with a prefix “a” can be converted to a bit-string “0110 0001” or a list of tokens that represent the bit-string “0110 0001”. A token associated with a prefix “a” can be converted to a bit-string “0110 0001”. The bit-strings that represent the sub-token lists can be used to create a binary tree.

FIG. 3B is a diagram illustrating an example of slice compression according to the present disclosure. FIG. 3B includes a binary tree 304-1, a binary tree 304-2, and a shaped graph 308. The binary tree 304-1 and the binary tree 304-2 can be created based on the sub-token list 334-1 and the sub-token list 334-2 in FIG. 3A, respectively.

The binary tree 304-1 that is associated with the sub-token list 334-1 can include the nodes 306-1, 306-2, 306-3, 306-4, 306-5, and 306-6, e.g., referred to generally as nodes 306. The node 306-1 can be associated with a common prefix 320-1 that has a value of “0110 001”. Common prefix 320-1 can be derived from the tokens “b”, “bc”, “bd”, and “c” in FIG. 3A. For example, the token “b” can have a bit-string representation of “0110 0010” and the token “c” can have a bit-string representation of “0110 0011”. Both the tokens “b” and “c” can share the common prefix “0110 001”. The node 306-4 can share a common prefix 320-2 with a “1100” value, wherein common prefix 320-2 is associated with tokens “c” and “d” in tokens “bc” and “bd” in sub-token list 334-1 in FIG. 3A, respectively. The binary tree 304-2 that is associated with the sub-token list 334-2 can include the nodes 306-7 and 306-8.

The shaped graph 308 can be created from binary tree 304-1 and binary tree 304-2. The shaped graph 308 can include the compressed nodes 312-1, 312-2, 312-3, 312-4, and 312-5. The compressed nodes 312-1, 312-2, 312-3, 312-4 can be associated with binary tree 304-1. The compressed nodes 312-5 and 312-4 can be associated with binary tree 304-2. The shape graph associated with binary tree 304-1 and the shaped graph associated with binary tree 304-2 can be combined when the compressed nodes in the shaped graphs share the same shape IDs. For example, the nodes 306-5 and 306-6 in binary tree 304-1 and the node 306-8 in binary tree 304-2 can have a same shape ID, e.g., shape ID 1. The two shaped graphs can be combined at a compacted node 312-4 that represents the nodes 306-5, 306-6, and 306-8 to create the shaped graph 308.

In a number of examples, an indexed shaped graph (not shown) can be created from shaped graph 308. An index table (not shown) can be created from the indexed shaped graph and/or the binary trees 304-1 and/or 304-2.

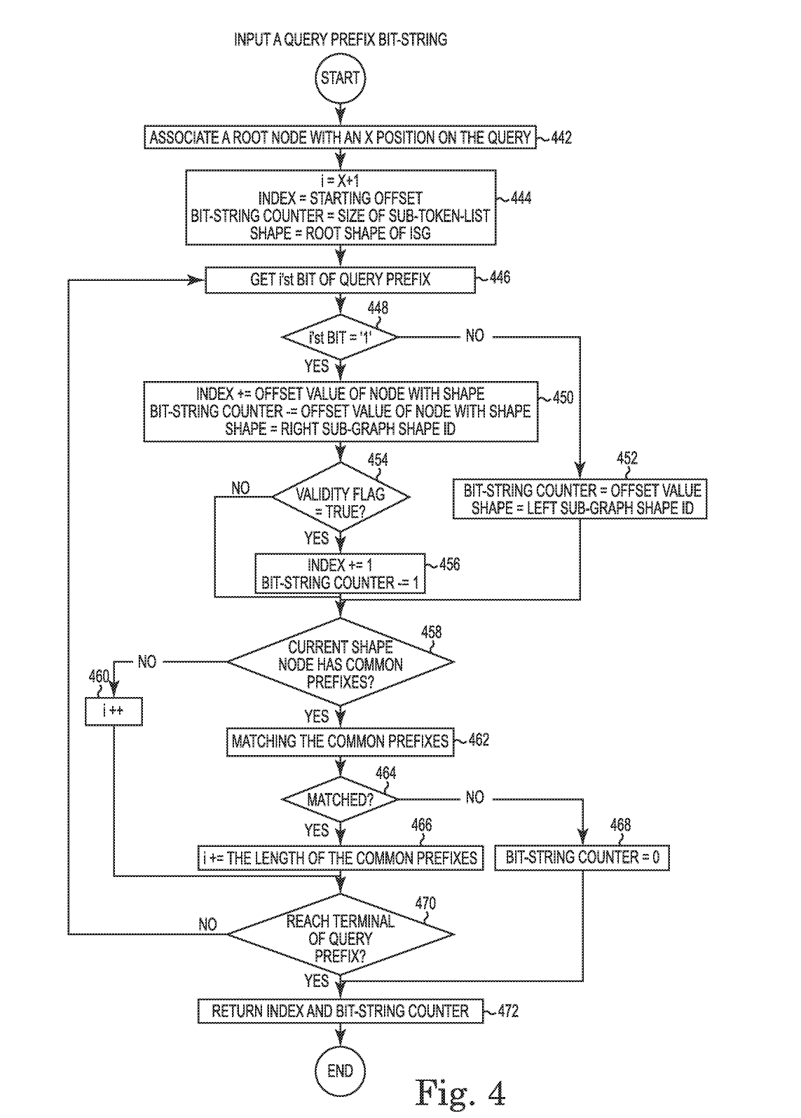

FIG. 4 is a flowchart illustrating an example of query look-up according to the present disclosure. A query can be a bit-string. A query can be provided by a user. For example, a user may provide the text “ab” and/or a number “1”. The text and/or the number can be converted to a bit-string. The bit-string, text, and/or number can be a prefix.

A query can be made to identify which bit-strings from a number of bit-strings stored in an indexed shaped graph include the prefix provided. For example, a user may provide the prefix, e.g., query prefix, “0110”. It can be determined that a number of bit-strings include the query prefix “011”. For example, the bit-strings, “0110 0001”, “0110 0010”, and “0110 0011” can include the query prefix “0110”.

The ability to look-up bit-strings that share a prefix can be useful, for example, when a user enters text into an address bar in a browser. A number of bit-strings that are stored in an indexed shaped graph can be a number of addresses that a user has entered into an address bar in the past. A user may enter a few characters of text and the address bar may provide a number of lists of text that have been entered in the past, wherein the lists of text include the few characters of text as a prefix.

At 442, a portion of the bit-string can be associated with a root node. For example, if a query prefix has an “ab” value, if the bit-string representation of the query prefix is “0110 0001 0110 0010”, and if the indexed shaped graph that is associated with the shaped graph 308 in FIG. 3B is the data structure on which we are performing the query, then a root node 312-1 can be associated with the bits “0110 001” in the query prefix “0110 0001 0110 0010”, wherein the bits “0110 001” represent the ninth position through the fifthteenth position of the query prefix. A position on a bit-string can be described using an i variable. For example, an i variable with a value equal to 1 can describe a first position on a prefix “0110 0001 0110 0010” wherein the bit associated with the first position is “0”, e.g., “0110 0001 0110 0010”.

At 444, a number of variables are set. The value of the i variable can be set by:

i=x+1

wherein x is the position of a prefix that is associated with a root node of a indexed shaped graph and wherein i is set to x+1. An index variable is set to:

index=starting offset

wherein the starting offset is the first index associated with an index table. An index variable can be used to associate an index with a bit-string ID by referencing an index table. A bit-string counter variable is set to:

bit-string counter=size of sub-token-list

wherein size of the sub-token list includes the number of valid nodes, e.g., valid compressed nodes, in the indexed shaped graph. A shape variable is set to

shape=root shape id

wherein the root shape ID is an shape ID associated with a root node. For example, node 312 in FIG. 3B can have a shape ID with a “4” value.

At 446, the i's bit of a query prefix is obtained. If the query prefix has a “010” value and if i is equal to 1, then the bit obtained from the query prefix at the i position is the “0” bit. At 448, it is determined if the i's bit is equal to “1”. If the query prefix is “010” and if the i position has a value or 1, then the first bit is not equal to “1” because the first bit is “0”.

At 452, a bit-string counter is set to an offset value associated with a compressed node that has a shape ID equal to the shape variable. For example, if the shape is “6”, e.g., shape ID that describes a compressed node, and if the data structure is indexed shaped graph 110 in FIG. 1C, then a bit-string counter will be equal to “3” because the compressed node 112-1 in FIG. 1C is associated with an offset value “3”. That is, from the root node an edge associated with “0” will be followed and there are three valid nodes in the left sub-graph, e.g., path associated with the edge that is associated with “0”.

At 450, the index variable, the bit-string counter variable, and the shape variable are given new values. The offset value of the node with a shape ID equal to the shape variable is added to the index. That is, the offset value of a node is used to create an index that is used to identify a bit-stream that matches the query prefix. An offset value that is associated with a node that has a shape ID equal to the shape variable is subtracted from the bit-string counter variable. The shape variable is set to the shape ID of a right sub-graph. In FIG. 4, the characters “-=” indicate decrementing the variable to the left of the characters “−=” by a value equal to the variable and/or number to the right of the characters “−=”. The characters “+=” indicate increasing the variable to the right of the characters “+=” by a value equal to the variable and/or number to the right of the characters “+=”.

At 454, it is determined if a compressed node that has a shape ID equal to a shape variable is a valid compressed node. If the shape variable identifies a compressed node that is a valid compressed node, then the index variable is incremented by one and the bit-string counter variable is decremented by 1.

At 458, it is determined if a compressed node associated with the shape variable has an associated common prefix. If the compressed node that is associated with the shape variable does have a common prefix, then at 462 and 464, it is determined if the common prefix matches the i positions of the query prefix. For example, if the common prefix is “10”, if the query prefix is “010001”, and if the i variable has a value of 2 then the query prefix contains the common prefix and at 466 the i variable is advanced based on the length of the common prefix. If the common prefix is not contained in the query prefix at the i variable position, then at 468, the bit-string counter is set to zero which indicates that non of the bit-strings in the indexed shaped graph are associated with the query prefix.

At 460, if the compressed node that is associated with a shape ID described by the shape variable does not have a common prefix then the i variable is incremented by one. The characters “++” in FIG. 4 indicate incrementing the variable to the left of the characters “++” by one. That is, the next bit in the query prefix is evaluated. At 470, it is determined whether the end of the query prefix has been reached. If the end of the query prefix has been reached then at 472, the index variable and the bit-string variable are returned. If the end of the query prefix has not been reached at 470, then at 446, the next bit from the query prefix is retrieved and evaluated.

The index variable and the bit-string counter variable can describe all of the bit-strings that are associated with the query prefix. For example, if an index variable is equal to “0”, if the bit-string counter is equal to “3”, and if an index table 114 in FIG. 1C is used to reference the bit-strings that are associated with a query prefix, then the index variable indicates that a “0” index in index table 114 in FIG. 1C can be used to identify the bit-string 001 that has a bit-string ID with a “P2” value. The bit-string counter with a “3” value can indicate that the indexes “0”, “1”, and “2”, in index table 114 in FIG. 1C are associated with the query prefix. This can be the case, when for example, the query prefix has a “0” value. That is the bit-strings “0”, “001”, and “010” have a common prefix “0”.

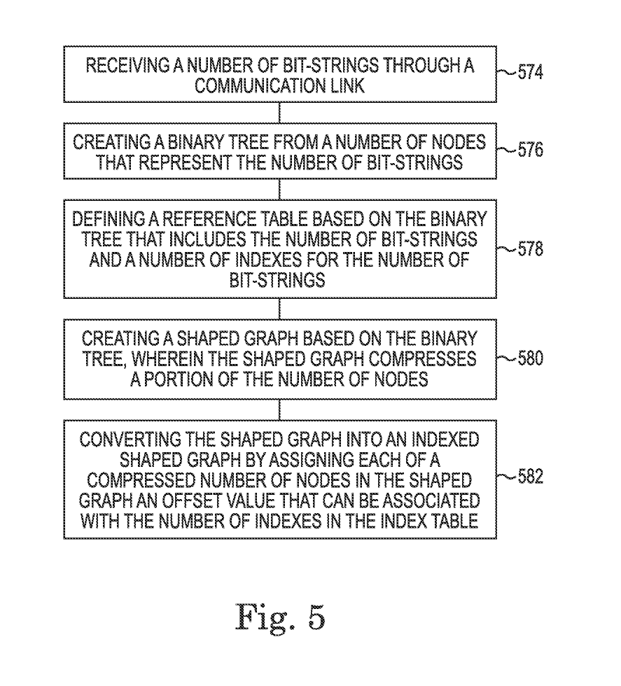

FIG. 5 is a flow chart illustrating an example of a method for indexed shaped graph creation according to the present disclosure. At 574, a number of bit-strings can be received through a communication link. The communication link can receive a number of bit-strings from a user and/or from a different source. For example, a different data structure can be converted to an indexed shaped graph wherein the bit-strings are received from a computing device through the communication link.

At 576, a binary tree is created from a number of nodes that represent the number of bit-strings. The bit-strings can be inserted into a binary tree using a number of tokens that represent the bit strings and/or by inserting the bit-strings directly into the binary tree.

At 578, an index table can be defined based on the binary tree that includes the number of bit-strings and a number of indexes for the number of bit-strings. The traversal order of a number of valid nodes can define the indexing of the bit-strings. The indexing of the bit-strings can be used to identify the bit-strings that share a common prefix when looking-up a query prefix.

At 580, a shaped graph can be created based on the binary tree, wherein the shaped graph compresses a portion of the number of nodes. Nodes that have similar shapes can be condensed into a single node. The shapes of a number of nodes can be compared based on the triple, as “<left sub-node shape, right sub-node shape, validity flag>”. Nodes with the same triple can be assigned a unique shape ID that can be used to identify the nodes when traversing the nodes.

At 582, the shaped graph can be converted into an indexed shaped graph by assigning each of a compressed number of nodes in the shaped graph an offset value that can be associated with the number of indexes in the index table. The offset values can be used to determine an index of a bit-string that contains a query prefix.

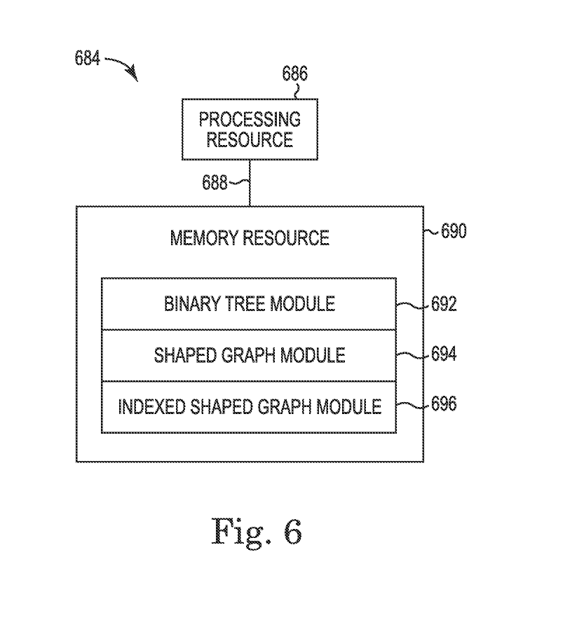

FIG. 6 is a diagram illustrating an example of a computing system according to the present disclosure. The computing system 684 can utilize software, hardware, firmware, and/or logic to perform a number of functions.

The computing system 684 can be a combination of hardware and program instructions configured to perform a number of functions, e.g., actions. The hardware, for example, can include one or more processing resources 686 and other memory resources 690, etc. The program instructions, e.g., machine-readable instructions (MRI), can include instructions stored on memory resource 690 to implement a particular function, e.g., an action such as indexed shaped graph creation.

The processing resources 686 can be in communication with the memory resources 690 storing the set of MRI executable by one or more of the processing resources 686, as described herein. The MRI can also be stored in a remote memory managed by a server and represent an installation package that can be downloaded, installed and executed. A computing device 684, e.g., server, can include memory resources 690, and the processing resources 686 can be coupled to the memory resources 690 remotely in a cloud computing environment.

Processing resources 686 can execute MRI that can be stored on internal or external non-transitory memory 690. The processing resources 686 can execute MRI to perform various functions, e.g., acts, including the functions described herein among others.

As shown in FIG. 6, the MRI can be segmented into a number of modules, e.g., a binary tree module 692, a shaped graph module 694, and an indexed shaped graph module 696, that when executed by the processing resource 686 can perform a number of functions. As used herein a module includes a set of instructions included to perform a particular task or action. The number of modules 692, 694, and 696 can be sub-modules of other modules. For example, the binary tree module 692 and the shaped graph module 694 can be sub-modules and/or contained within a single module. Furthermore, the number of modules 692, 694, 696 can comprise individual modules separate and distinct from one another.

In the example of FIG. 6, a binary tree module 692 can comprise MRI that are executed by the processing resources 686 to create a binary tree. The binary tree can be a data structure that includes a number of bit-strings. The bit-strings can be received through a communication link at a computing device. The computing device can receive text convert the text into bit-string. The nodes associated with a binary tree can be modified to include a shape ID that can identify a unique shape associated with a number of nodes.

The shaped graph module 694 can comprise MRI that are executed by the processing resources 686 to include create a shaped graph. The shaped graph can be created based on the binary tree using a computing device. That is, a logic associated with the computing device can be executed to identify nodes from the binary tree that has the same shape ID. The logic can be executed to compress the nodes that share a shape ID into a single node and thus reduce the memory resources associated and/or consumed by the execution of the set of instructions that store the bit-stream in a shaped graph as compared to the execution of the set of instructions that store the bit-stream in a binary tree.

An indexed shaped graph module 696 can comprise MRI that are executed by the processing resources 686 to associate each of the condensed nodes in an shaped graph with a offset value to create an indexed shaped graph. The indexed shaped graph can be used to identify all of the nodes that include a prefix without having to iterate to a compressed node where each of the identified bit-streams terminates, e.g., each of the valid nodes that are associated with each of the identified bit-streams.

A memory resource 690, as used herein, can include volatile and/or non-volatile memory. Volatile memory can include memory that depends upon power to store information, such as various types of dynamic random access memory (DRAM) among others. Non-volatile memory can include memory that does not depend upon power to store information.

The memory resource 690 can be integral or communicatively coupled to a computing device in a wired and/or wireless manner. For example, the memory resource 690 can be an internal memory, a portable memory, and a portable disk, or a memory associated with another computing resource, e.g., enabling MRIs to be transferred and/or executed across a network such as the Internet. The memory resource 690 can be in communication with the processing resources 686 via a communication path 688. The communication path 688 can be local or remote to a machine, e.g., a computer, associated with the processing resources 686.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processing.

As used herein, “a” or “a number of” something can refer to one or more such things. For example, “a number of widgets” can refer to one or more widgets.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

What is claimed:

1. A method for index shaped graph creation comprising:
receiving a number of bit-strings through a communication link;
creating a binary tree from a number of nodes that represent the number of bit-strings;
defining an index table based on the binary tree that includes the number of bit-strings and a number of indexes for the number of bit-strings;
creating a shaped graph based on the binary tree, wherein the shaped graph compresses a portion of the number of nodes; and
converting the shaped graph into an indexed shaped graph by assigning each of a compressed number of nodes in the shaped graph an offset value that can be associated with the number of indexes in the index table.

2. The method of claim 1, wherein creating the shaped graph based on the binary tree includes defining a number of edges between the number of nodes and defining a direction to the number of edges such that each edge has one of a left direction or a right direction.

3. The method of claim 1, wherein creating the shaped graph includes assigning the number of nodes in the binary tree a number of shape identifications (ID) that define a number of shapes associated with the number of nodes, wherein nodes with a same shape have a same shape ID.

4. The method of claim 3, wherein associating each of the number of nodes in the binary tree with the number of shape ID includes defining the shape of each of the number of nodes by a left sub-tree shape, a right sub-tree shape, and a validity flag that indicates whether one of the number of bit-strings terminates at one of the number of nodes that is associated with the validity flag.

5. The method of claim 3, wherein the method includes compressing nodes with the same shape ID into a single node.

6. The method of claim 1, wherein compressing of the number of nodes begins at a number of leaf nodes and proceeds to a root node.

7. A non-transitory machine-readable medium storing instructions for index shaped graph creation executable by a machine to cause the machine to:
receive a number of bit-strings through a communication link;
create a first compact binary tree from a first portion of the number of bit-strings and a second compact binary tree from a second portion of the number of bit-strings;
wherein the first portion of the number of bit-strings is based on a first prefix associated with the number of bit-strings and the second portion of the number of bit-strings is based on a second prefix associated with the number of bit-strings; and
wherein the first compact binary tree includes a first number of nodes that represent the first portion of the number of bit-strings and wherein the second compact binary tree includes a second number of nodes that represent the second portion of the number of bit-strings;
define an index table based on the binary tree that includes the number of bit-strings and a number of indexes for the number of bit-strings;
create a shaped graph based on the first binary tree and the second binary tree by including the first number of nodes and the second number of nodes in the shaped graph, wherein the shaped graph compresses a portion of the first number of nodes and the second number of nodes into a single node; and
convert the shaped graph into an indexed shaped graph by assigning each of a compressed number of nodes in the shaped graph an offset value that can be associated with the number of indexes.

8. The medium of claim 7, wherein the instructions executable to convert the shaped graph into the indexed shaped graph include instructions to assign the offset value for each of the compressed number of nodes based on the number of bit-strings that are associated with each of the compressed number of nodes.

9. The medium of claim 8, wherein the instructions executable to assign the offset value for each of the compressed number of nodes include instructions to assign the offset value for each of the compressed number of nodes equal to a number of concluding nodes that conclude in a left sub-graph.

10. The medium of claim 7, wherein the instructions executable to assign the offset value for each of the compressed number of nodes include instructions to assign the offset value for each of the compressed number of nodes equal to a number of concluding nodes that conclude in a right sub-tree.

11. A system for index shaped graph creation, comprising:
a processing resource in communication with a memory resource,
wherein the memory resource includes a set of instructions, executable by the processing resource to:
create an indexed shaped graph that is based on a binary tree,
wherein the indexed shaped graph includes less nodes than the binary tree and wherein the indexed shaped graph includes a representation of a number of bit-strings in the form of a number of compressed nodes;
define an index table based on the binary tree that includes the number of bit-strings and a number of indexes for the number of bit-strings;
receive a query prefix in the form of a bit-string;
associate an index with one of the number of bit-strings that includes the query prefix and a bit-string count with a portion of the number of bit-strings that include the query prefix, wherein the association is based on the indexed shaped graph and the index table.

12. The system of claim 11, wherein the instructions executable to associate the index with one of the number of bit-strings and the bit-string count with the portion of the number of bit-strings includes instructions to traverse the indexed shaped graph based on the query prefix.

13. The system of claim 12, wherein the instructions executable to traverse the indexed shaped graph include instructions to follow a path in the indexed shaped graph that corresponds to the query prefix and at each compressed node in the path calculate update the index and the bit-string count.

14. The system of claim 13, wherein the instructions executable to update the index and the bit-string count include instructions to:
when one of the number of bits from the query prefix is equal to 1:
update the index by adding an offset value that is associated with one of the number of compressed nodes to the index; and
update the bit-string count by subtracting the offset value that is associated with the one of the number of compressed modes from the bit-string count; and
when the character from the query prefix is equal to 0, update the bit-string counter by setting the bit-string counter equal to the offset value that is associated with one of the compressed number of nodes.

15. The system of claim 11, wherein the instructions executable to associate the index with one of the number of bit-strings and the bit-string count with the portion of the number of bit-strings include instructions to:
associate the index with one of the number of indexes from the index table and an associated bit-string; and
associate the bit-string count with the portion of the number of bit-strings that follow the one of the number of indexes, wherein the portion of the number of bit-strings includes as many bit-strings as the value of the bit-string count.
